(19) United States
(12) Patent Application Publication
(10) Pub. No.: US 2019/0083345 A1
(43) Pub. Date: Mar. 21, 2019

(54) Accessory Pad for Medical Examination Device

(71) Applicant: United Metal Fabricators, Inc. d/b/a UMF Medical, Johnstown, PA (US)

(72) Inventors: Joseph Romano, Johnstown, PA (US); Eileen B. Melvin, Somerset, PA (US); Quinn Carpenter, Johnstown, PA (US)

(73) Assignee: United Metal Fabricators, Inc. d/b/a UMF Medical, Johnstown, PA (US)

(21) Appl. No.: 16/137,065

(22) Filed: Sep. 20, 2018

Related U.S. Application Data
(60) Provisional application No. 62/560,973, filed on Sep. 20, 2017.

(51) Int. Cl. A61G 13/12; A61G 13/00

(52) U.S. Cl. CPC A61G 13/125; A61G 13/0018; A61G 13/02; A61G 13/0036; A61G 13/129; A61G 13/1245

(57) ABSTRACT

An accessory pad is selectively and removably mountable to a footrest of a medical examination device to fill in space between the footrest and seat cushion of the medical examination device and forms a substantially co-planar surface for patient support. The accessory pad has a body with upper and lower surfaces and at least one side. A recess configured to receive and restrain a portion of a footrest is formed in at least one of the lower surface and side of the body and may form a snug fit therewith. When installed, the upper surface of the accessory pad is substantially co-planar with the upper surface of the seat cushion. The accessory pad may also be adjacent to the seat cushion, forming a substantially continuous support surface with the seat cushion. Fastener(s) and restraint member(s) may be included to further secure the accessory pad in place.

### CLAIM OF PRIORITY

The present application claims priority to U.S. Provisional Application Ser. No. 62/560,973 filed on Sep. 20, 2017, the contents of which are incorporated herein by reference in its entirety.

### FIELD OF THE INVENTION

This invention relates to the field of medical examination tables and footrests therefor. More specifically, it relates to the establishment of a generally planar and consistent surface for such tables to support a patient and a patient's movement thereon.

### BACKGROUND

Medical examination tables and chairs are extensively used throughout many various disciplines of medicine to facilitate the examination of and administer therapy to patients. Many of the currently used models are primarily power actuated tables and chairs with electric motors for adjustment of the seat and back portions, such as is shown in the UMF Medical Model 4040-650-300. In most embodiments, a movable footrest portion is provided which is generally slidable into the housing of the examination table for storage and extended only when needed for a patient. As the slidable portion must be enclosed within the support housing or base of the examination table, the upper generally planar surface of the footrest when extended is lower than the generally planar surface of the seat portion of the examination table. This discrepancy in height between the support surface of the seat and that of the footrest creates an uncomfortable position for the legs when extended. Moreover, certain examinations and procedures require a patient to be in a fully flat position, which therefore requires the legs to be at the same height as the rest of the body. This is not possible with the current medical examination tables.

Some have tried to alleviate the height discrepancy by adding pillows between the patient's legs and the footrest below. This approach may not get the patient's legs or feet to the particular height desired, depending on the dimensions of the available pillows. Even if the right height is achieved, it is often fleeting as the pillows easily shift when the patient moves around on the table. This creates a potentially dangerous situation in which the patient is not being stably supported. Such stable support is particularly important for individuals who have a difficult time moving around due to disability, infirmity, paralysis or partial paralysis, weakness, and the like, and therefore tend to lean heavily on certain areas when moving and often cannot react quickly to positional changes.

The prior art includes movable articulated footrests in medical examination tables, such as disclosed in U.S. Pat. No. 4,034,972 and in particular, FIG. 3, element 150. Padded and removable footrest portions are also disclosed, in U.S. Pat. No. 7,669,259, and in particular, FIG. 17, element 146.

However, the prior art does not recognize the shortcomings of a footrest which is not co-planar with the seat portion of the medical, examination table, particularly in consideration of the need to reposition patients on the table. This can be particularly important for orthopedic patients requiring immobilization of legs, knees and hips, such as in pre-operation, operation, post-operation and other examinations. Additionally, disabled patients, including those with partial. paralysis, find prior art designs difficult to navigate, particularly while positioning themselves on such tables. What is lacking in the art, therefore, is a substantially planar medical examination table, including the foot rest area.

### SUMMARY

A removable accessory pad for a medical examination device is disclosed. The accessory pad is configured to be mounted to an extended footrest of a medical examination device, such as a table or chair, to fill in the gaps between the footrest and the seat cushion of the medical examination device, thus forming a substantially co-planar and continuous support surface for a patient's legs and/or feet. The accessory pad fits snugly on the footrest of the medical examination device so it resists wobbling or shifting even as the patient shifts or positions themselves on the medical examination device. When not in use, the accessory pad may be removed from the footrest, allowing the footrest to be retracted to a storage position so the patient can get on and off the medical examination device. Because it movable, the current accessory pad may be retrofitted to any existing medical examination device that has a footrest that deploys to a position lower than the seat cushion. It is also temporary, so it is only used when needed and for the patients, examinations and/or procedures that require or benefit from the patient being substantially flat.

The accessory pad includes a body formed of an upper surface, a lower surface, and at least one side. The accessory pad may be any shape, configuration or dimension, but is preferably at least the size of the portion of the footrest to which it is mounted. In at least one embodiment, the accessory pad is generally rectangular and may have rounded or curved edges for comfort and style. The body is formed of a resilient material such as padding, which may be covered by upholstery to increase durability and allow for cleaning and surface sterilization between patients. The resilient material is compressible for patient comfort and yet provides sufficient support while compressed, and further rebounds to its natural dimensions when uncompressed. In some embodiments, the body may also include a rigid substrate to which the resilient material and/or upholstery may be secured, to provide structural support to the accessory pad.

The accessory pad includes a recess formed in the body which is dimensioned to receive and restrain at least a portion of the footrest, such as the footrest pad or a portion thereof. The recess is formed in at least one surface of the body, such as the lower surface, one side, multiple sides, and combinations thereof. Accordingly, the accessory pad may be mounted on the footrest by aligning the recess with the footrest and lowering and/or sliding the accessory pad toward the footrest until the footrest is located within the recess. The dimensions of the recess may be substantially the same or similar to those of the footrest, such that a snug fit is formed with the accessory pad is mounted on the footrest. This snug fit limits the movement of the accessory pad on the footrest once mounted thereon, such as might occur from a patient shifting their weight or adjust position on the accessory pad.

In some embodiments, the accessory pad may include at least one fastener and/or at least one restraint member to further secure the accessory pad to the footrest. The fastener(s) may be hook and loop fasteners, snaps, buttons, removable adhesive and other selective type fasteners. The restraint member may be a strap, rope, belt, or other elongate member that may at least partially encircle the accessory pad and/or footrest to secure them together and may be released when the removal of the accessory pad is desired. The restraint member may engage a fastener, such as when the restraint member includes a hook and loop fastener at one end that engages complementary hook and loop fastener located on the body of the accessory pad. The fasteners and restraint member(s) may be located anywhere on the body of the accessory pad, including sides and the lower surface. In some embodiments, they may be located on interior surfaces of the recess and may engage corresponding structure on the footrest.

At least a portion of the body of the accessory pad fills the gaps between the footrest and the seat cushion of the medical examination device when mounted. For instance, the body of the accessory pad fills the vertical space between the top of the footrest and the upper seat surface of the seat cushion of the medical examinations device, thus creating a substantially co-planar surface between the upper seat surface of the seat cushion and the upper surface of the accessory pad. The accessory pad may also be mounted on the footrest so it is adjacent to the seat cushion of the medical examination device. The body may therefore also fill longitudinal space between the edge of the footrest and the nearest edge of the seat cushion, thus filling in any gaps between the footrest and the edge of the medical examination device from which the patient's legs extend.

The back of the medical examination device may also be raised and lowered to adjust the degree of recline. When fully lowered, the back cushion may be level with the seat cushion and be co-planar therewith, further extending the substantially planar and continuous support surface for the patient to the entire length of the medical examination device, which facilitates positioning of patients while resting thereon and particularly facilitates self-positioning of partially paralyzed patients with limited control of their lower extremities.

The accessory pad and medical examination device, together with their particular features and advantages, will become more apparent from the following detailed description and with reference to the appended drawings.

### DESCRIPTION OF THE DRAWINGS

FIG. 1 is side perspective view of an embodiment of the accessory pad of the present invention showing a first side and an upper surface.

FIG. 2 is a perspective view of the accessory pad of FIG. 1, showing a second side.

FIG. 3 is a side perspective view of the accessory pad of FIG. 1, showing the opposite lower surface and recess.

FIG. 4 is a back perspective view of the accessory pad of FIG. 3 with a restraining member engaging a fastener.

FIG. 5 is a bottom perspective view of a second embodiment of the accessory pad of the present invention, showing the recess, interior surfaces and fasteners.

FIG. 6 is a perspective diagram of a third embodiment of the accessory pad of the present invention showing an interior recess accessible through one side of the body.

FIG. 7 is a perspective diagram of a fourth embodiment of the accessory pad of the present invention showing the recess formed in the lower surface of the body and accessible from underneath.

FIG. 8 is a diagram of a medical examination device with extended footrest and the accessory pad of FIG. 1 shown in exploded alignment therewith.

FIG. 9 is a diagram of the medical examination device of FIG. 8 with an exemplary accessory pad installed on the footrest.

FIG. 10 is a top perspective view of the medical examination device and an accessory pad when installed.

FIG. 11 is a side elevation view of the medical examination device and accessory pad of FIG. 8.

FIG. 12 is a front perspective view of the medical examination device and accessory pad of FIG. 8.

FIG. 13 is a plan view of the underside of the end of the medical examination device and accessory pad of FIG. 8 showing attachment of the accessory pad to the underside of the footrest.

Like reference numerals refer to like parts throughout the several views of the drawings.

### DETAILED DESCRIPTION

As shown in the accompanying drawings, the present invention is directed to an accessory pad 10 that is selectively attachable to a footrest 35 of a medical examination device 30, such as a medical examination table or chair. It can be used in connection with any type of medical examination table, including powered tables and non-powered tables such as box tables. The accessory pad 10 is dimensioned to be substantially co-planar with the seat cushion 32 of the medical examination device 30 when attached to the footrest 35.

The accessory pad 10 is composed of a body 19 made primarily of a resilient material that provides sufficient compression to be comfortable to the patient but also sufficient stiffness and/or resilience to provide support to a patient's legs and feet when placed thereon. As used herein, the term “resilient” means the material may be compressed or slightly deformed and will return to its uncompressed state when the compressing or deforming pressure is released. The resilient material may include, but is not limited to rubber, silicone, polymeric materials, composite materials, memory foam, beads or microbeads, and gel- or fluid-filled cushion. In some embodiments, the resilient material may be attached to a substrate which provides structural support to the accessory pad 10. For instance, the substrate may be made of wood, plastic, polymeric material, metal and metal alloys, or combinations thereof. A layer of upholstery may encase the padding and secure it against the substrate and may also lend a degree of structural support and/or resilience to the accessory pad 10. For instance, the upholstery may include but is not limited to cloth, microfiber, cotton, synthetic blends, nylon, polyester, leather, synthetic or imitation leather, rubber, silicone and combinations thereof, and may further include stitching. In some embodiments, however, the resilient material is sufficiently self-supporting that a substrate is not needed, and the upholstery is provided as a cover.

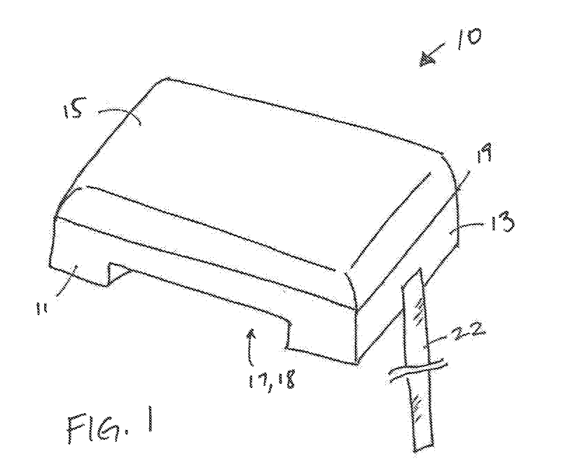

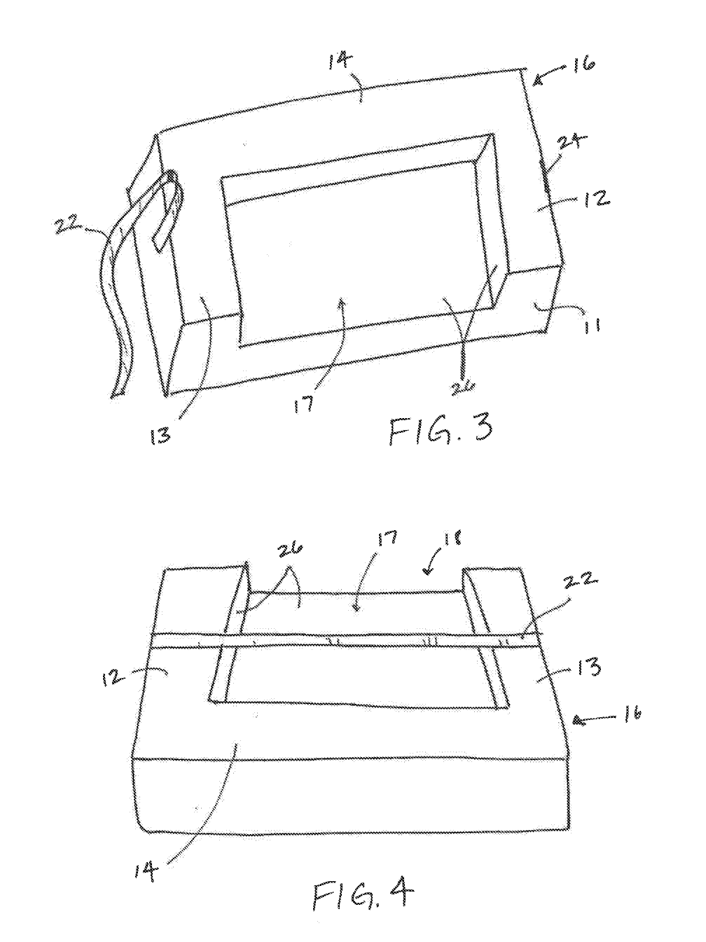

As shown in FIGS. 1-7, the body 19 of the accessory pad 10 includes an upper surface 15, opposite lower surface 16, and at least one side connecting the upper and lower surfaces 15, 16. For example, in the embodiments shown in. FIGS. 1-7, the body 19 may be rectangular in shape and may include a first side 11, second side 12, third side 13, fourth side 14. The upper surface 15 is configured to receive the legs) and/or feet of a patient when in position on a medical examination device 30, and therefore forms a support surface. Although shown here as rectangular, the body 19 of the accessory pad 10 may have any shape and configuration. For instance, in some embodiments, the body 19 may be square, oval, oblong, or irregular in shape and dimension. The body 19 of the accessory pad 10 may also have any suitable dimensions that would accommodate a footrest 35 of a medical examination device 30. For instance, the body 19 may have a width in the range of 20 to 34 inches, and may be about 28 inches in some embodiments; a length in the range of 10 to 25 inches and in some embodiments about 17.5 inches; and an uncompressed height in the range of 1 to 10 inches, such as about 7 inches. Of course, other dimensions and configurations are also possible. Further, in at least one embodiment, the edges and/or corners of the accessory pad 10 may be rounded for comfort and aesthetics. Any degree of curvature may be employed that would be suitable for the overall dimensions of the accessory pad 10, such as in the range of 1 inch to 5 inch radius, and preferably about 2 inch radius.

A recess 17 is formed in the body 19 of the accessory pad 10. This recess 17 is dimensioned to receive and restrain at least a portion of the footrest 35 of a medical examination device 30 therein. The recess 17 is therefore at least the same dimensions or greater than a portion of the footrest 35. In certain embodiments, the recess 17 is correspondingly shaped and dimensioned to the footrest 35 or a portion thereof so as to form a snug, frictional fit with the footrest 35 when the accessory pad 10 is attached thereto. For instance, the recess 17 may be rectangular in shape and measure about 19.5 inches wide by 2.25 inches high and 12.5 inches long, which corresponds to typical footrest pad 36 shape and dimensions for medical examination tables. In other embodiments, the recess 17 may be shallower than the entire footrest 35 and may merely attach to the top of the footrest 35 without entirely covering it.

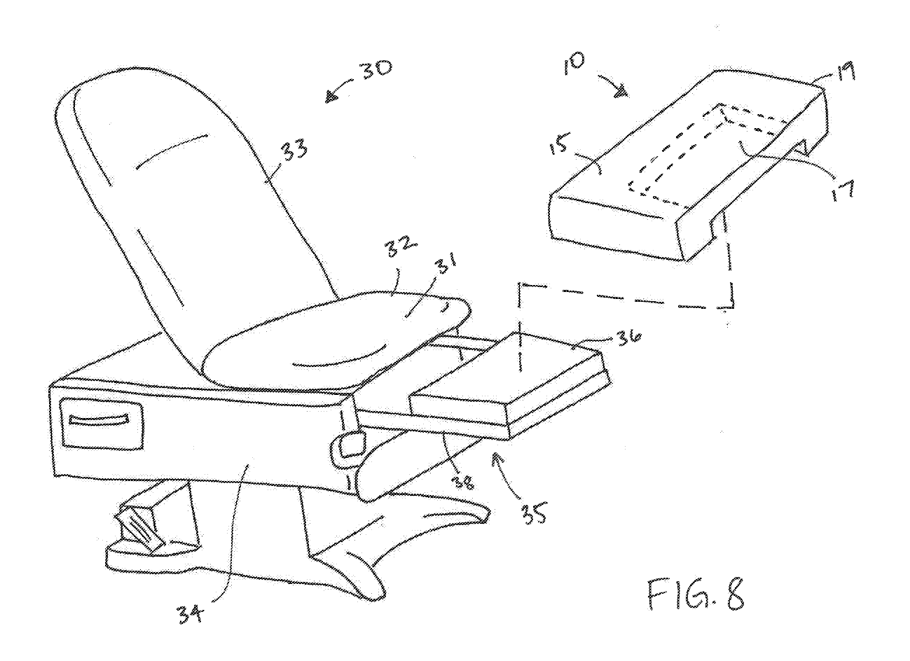

The recess 17 may be formed anywhere within the body 9 of the accessory pad 10. For instance, the recess 17 may be bounded by the upper surface 15 and at least one side of the body 19. In some embodiments as shown in FIGS. 1-4, the recess 17 may be formed in the lower surface 16 and a portion of a first side 11 of the body 19. In such embodiments, the second, third and fourth sides 12, 13, 14 and the upper surface 15 form the boundaries of the recess 17. In other embodiments, such as shown in FIG. 7, the recess 17 may be formed in lower surface 16 such that all sides form boundaries of the recess 17 and the opening 18 of the recess 17 is in the lower surface 16 of the body 19. In still other embodiments, as depicted in FIG. 6, the recess 17 may be formed in one of the sides of the body 19, such as the first side 11, although it could be formed in any of the sides. Accordingly, the recess 17 may be a three-dimensional space or void formed in the body 19 of the accessory pad 10 that is bounded on at least two sides by the body 19. In some embodiments, the recess 17 ay be bounded on four sides, as in FIGS. 1-4. In other embodiments, the recess 17 may be bounded on five sides, as in FIGS. 6 and 7. Further, as should be clear from the Figures, a portion of the body 19 extends between the recess 17 and the upper surface 15 of the body 19. This section of the body 19 is considered part of the upper surface 15. The areas bounding the recess 17 on the sides are considered sides 11, 12, 13, 14 of the body 19.

As shown in FIGS. 3-7, the recess 17 includes at least one interior surface 26 formed on the interior side of the body 19 at the boundaries of the recess 17. The interior surface 26 may refer o any of the surfaces of the recess 17, including interior walls, floor and ceiling. These interior surface(s) 26 may be upholstered similar to the upper surface 15 in many embodiments, though in other embodiments interior surface(s) 26 may not be upholstered. Such upholstering may increase the durability of the accessory pad 10 when mounting and removing it from the footrest 35. At least one of the interior side(s) 26 of the recess 17 contact and receive the footrest 35 when the accessory pad 10 is mounted thereto. Accordingly, in at least one embodiment, the interior surfaces 26 of the recess 17 may be collectively configured to correspond in size, shape and dimension to at least a portion of the footrest 35 for mounting thereto by snug, frictional fit to reduce undue wobble or shifting when the weight of the patient is applied thereto.

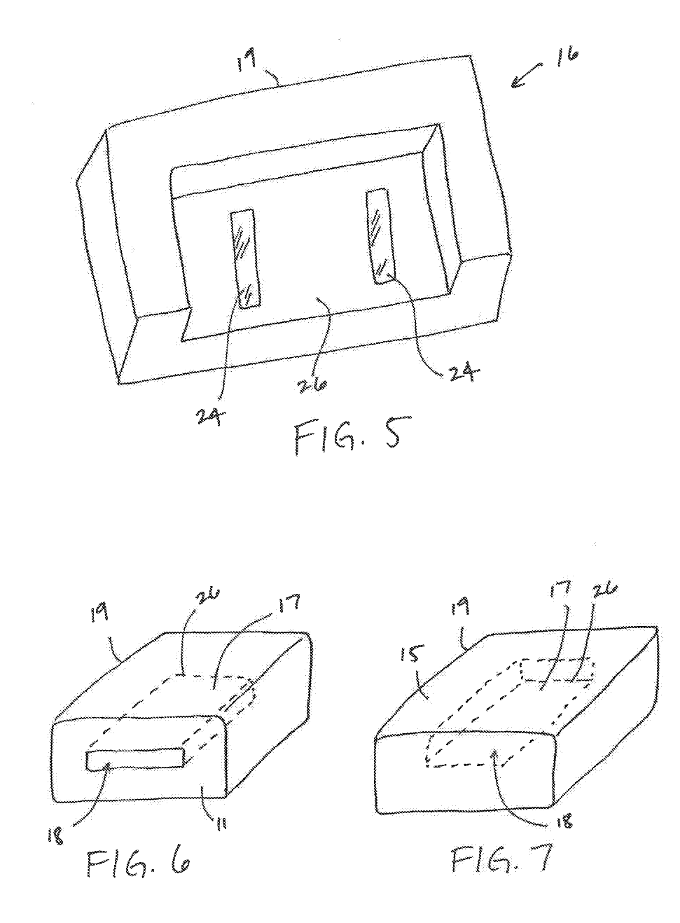

In some embodiments, it may be desirable to provide a more secure connection between the accessory pad 10 and footrest 35, to further limit movement of the accessory pad 10 thereon. The accessory pad 10 may therefore include at least one fastener 24 affixed to the accessory pad 10 to assist in securing the accessory pad 10 in position on the footrest 35. The fastener(s) 24 may be any suitable device that allows for selective, removable but secure connection, such as but not limited to hook and loop fasteners, snaps, buttons, reusable adhesive, and other selective fasteners. There may be any number of fasteners 24 which may be located anywhere along the body 19 of the accessory pad 10 as permits securing of the accessory pad 10 to the footrest 35. For instance, in some embodiments, fastener(s) 24 may be affixed to one or more interior surface 26 of the recess 17, such as shown in FIG. 5. In other embodiments, fastener(s) 24 may be located along the lower surface 16 or side of the body 19, such as on a second side 12 shown in FIGS. 1-4.

In some embodiments, the accessory pad 10 may include a restraint member 22 configured to support and restrain the body 19 of the accessory pad 10 on the footrest 35 when mounted thereto. In addition to any frictional fit that may occur between the recess 17 and the footrest 35, the restraint member 22 may further limit the lateral and longitudinal movement that may occur between the accessory pad 10 and the footrest 35, such as by the patient shifting their weight or the position of their legs and/or feet when supported on the accessory pad 10. The restraint member 22 may be a strap, belt, rope, or other elongate member(s), which may be the same or longer in dimension than the accessory pad 10. The restraint member 22 may be of any suitable material, such as but not limited to rope, nylon, polyester, natural fiber, synthetic fiber, fiber blends, plastic, rubber, polymeric material or other similar material, and may therefore be flexible, woven, rigid or resilient/elastic as the material dictates. In some embodiments, the restraint member 22 may be separate from but positioned against the accessory pad 10 and/or footrest 35 to restrain the accessory pad 10 in place. In other embodiments, the restraint member 22 may be secured to the body 19 of the accessory pad 10 and may be secured at any location along the body 19, such as but not limited to one of the sides. Of course, the accessory pad 10 may include any number of restraint members 22.

In certain embodiments, the accessory pad 10 may include both restraint member(s) 22 and fastener(s) 24 which may be configured to interact with each other to selectively attached the accessory pad 10 to the footrest 35 of the medical examination device 30, such as depicted in FIGS. 1-4. For instance, in one embodiment a restraint member 22 may be secured to a third side 13 of the accessory pad 10 and have an elongate length that reaches across the accessory pad 10, selectively securing at the other end to a fastener 24 located on the opposite second side 12. The restraint member(s) 22 and fastener(s) 24 may be located anywhere along the accessory pad 10, though preferably not on the upper surface 15. In still other embodiments, there may be multiple restraining members 22 and fasteners 24. In such embodiments, all the restraining members 22 may be located on one side 12, 13 and all the fasteners 24 on another side. In still other embodiments, various combinations of restraining members 22 and fasteners 24 may be located on a common side. In still other embodiments, the restraining members 22 and/or fasteners 24 may be located on a first or fourth side 11, 14 or on the lower surface 16.

The accessory pad 10 is selectively and removably mountable to a footrest 35 of a medical examination device 30 so that the upper surface 15 of the body 19 is substantially co-planar with the seat cushion 32 of the medical examination device 30 when mounted to the footrest 35. For instance, in at least one embodiment the upper surface 15 of the accessory pad 10 is substantially planar. It may be entirely planar, or may have areas of curvature, elevation or depression along certain areas such as an edge(s) of the upper surface 15. Even in such embodiments, however, there is at least a portion of the upper surface 15 that is planar or substantially planar in order to support the leg(s) and foot or feet of a patient thereon when applied to the footrest 35 of the medical examination device 30.

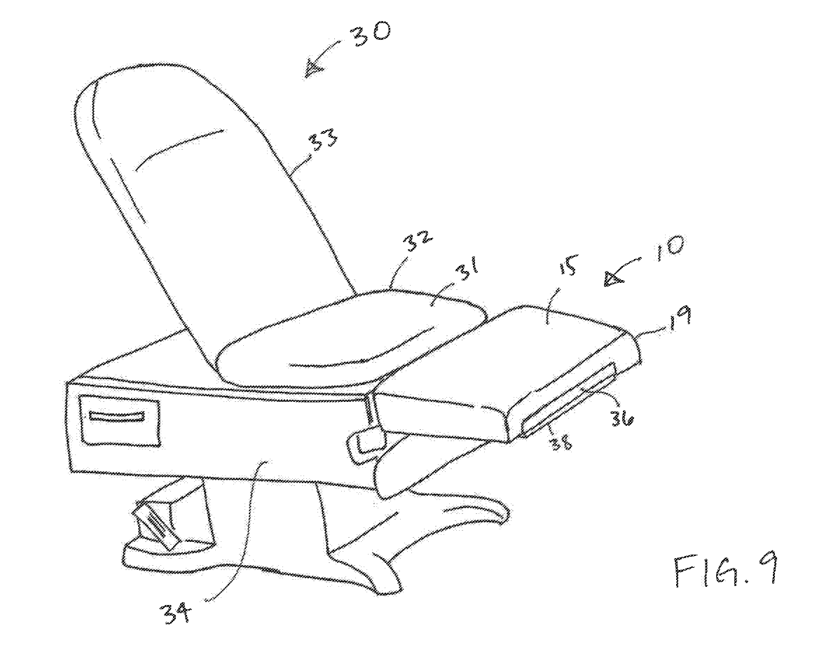

As noted above, the medical examination device 30 may be a table or chair that is used in examining a patient and/or providing treatment or therapy to the patient. Examples include but are not limited to examination tables and chairs used in general medicine, internal medicine, ear nose and throat (ENT), gynecology, proctology, pediatric, gastrointestinal, podiatry, rheumatology, dentistry, optometry, ophthalmology, and imaging. An exemplary embodiment is shown in FIGS. 8-9 in which a medical examination device 30 includes a base 34 supporting a seat cushion 32 and adjustable back cushion 33. The seat cushion 32 is affixed to the base 34 and includes an upper seat surface 31 on which a patient sits. Accordingly, the upper seat surface 31 is generally planar, although in certain embodiments it may include contouring to facilitate patient positioning. A back cushion 33 is separately affixed to the base 34 adjacent to the seat cushion 32 and is selectively adjustable relative to the surface of the base 34 to change the angle thereto, affecting the degree of recline. In a preferred embodiment, the back cushion 33 may be adjustable to a position that is parallel to the surface of the base 34 and therefore also level with the seat cushion 32. When so positioned, the back cushion 33 and seat cushion 32 may form a continuous, substantially planar surface on which a patient may be supported.

The medical examination device 30 further includes a footrest 35 that is selectively positionable relative to the base 34 to support a patient's legs and feet. When not in use, the footrest 35 is positionable out of the way of the patient and/or practitioner, such as within a cavity in the base 34 or along the outer surfaces of the base 34 on the front or sides thereof. When its use is desired, the footrest 35 may be extended outwardly from a stored position to any of a number of extended positions, such as shown in FIG. 8. In at least one embodiment, the base 34 includes a cavity in which the footrest 35 is stored, and the footrest 35 may be extended outwardly in a longitudinal direction from within the cavity to any number of positions outside the cavity. As used herein, “longitudinally” means in the length direction of the medical examination device. The footrest 35 may include rails 38 which may be extended outwardly from within the cavity in a sliding or telescoping fashion. The footrest 35 may also include a footrest pad 36 attached to the rails 38 that may therefore be stored within the cavity when not in use and pulled outwardly along the rails 38 to a use position. In other embodiments, the footrest 35 may be stored flush against a side of the base 34, such as a front, left or right side, where the front of the base 34 is defined as the side which a patient's legs extend over when seated on the medical examination device 30. The footrest 35 may therefore be extended outwardly from the base 34 by rotating up and/or around the base 34 to a use position. Accordingly, it is contemplated that any form or shape of articulated or sliding footrest 35 may be adapted with the addition of the accessory pad 10 described herein, and the footrest 35 may be positioned by linear, rotational, longitudinal, vertical and lateral movement and combinations thereof.

When the footrest 35 is positioned for use, it typically is spaced apart from the seat cushion 32 of the medical examination device 30. For instance, the top surface 37 of the footrest pad 36 is lower in the vertical direction than the upper seat surface 31 of the seat cushion 32. The footrest pad 36 may also be spaced a distance away from the seat cushion 32 in the longitudinal direction.

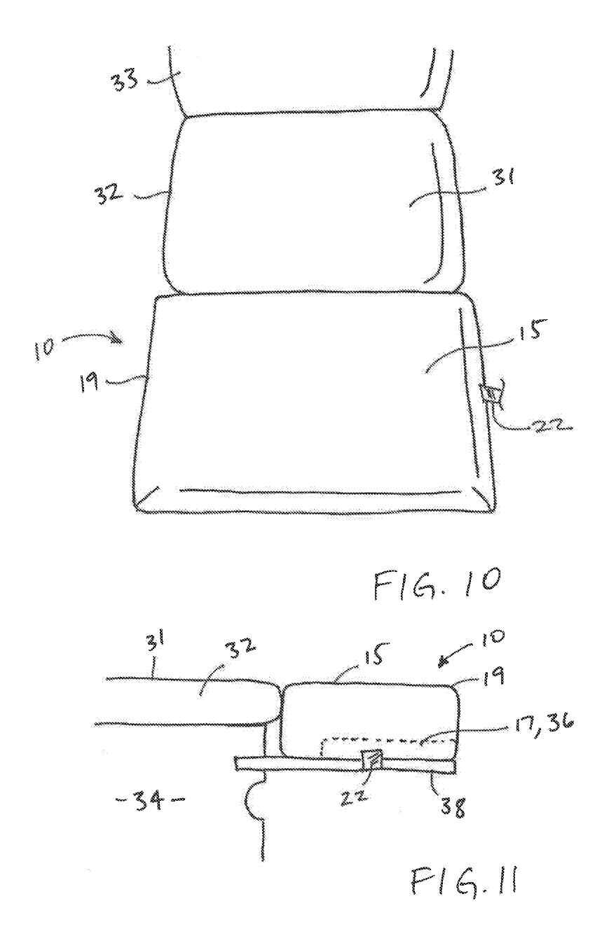

The accessory pad 10, when mounted on the footrest 35, cures one or both of these problems by filling in the spaces between the footrest 35 and the seat cushion 32 to make them flush, as shown in FIGS. 9-13.

Once the footrest 35 is positioned as desired in an extended position, the accessory pad 10 may be mounted thereto. In at least one embodiment, the recess 17 of the accessory pad 10 is aligned with the footrest pad 36 and the accessory pad 10 is placed on the footrest 35. This is depicted schematically in FIG. 8. Although only one embodiment of the recess 17 is shown in FIG. 8, it should be appreciated that any recess 17 configuration may be included in the accessory pad 10 and it be applied in a similar manner, such as but not limited to those shown in FIGS. 6 and 7. For instance, when the recess 17 is formed in the lower surface 16 and a front side 11, as in FIG. 8, the accessory pad 10 may be placed on the footrest 35 from above and/or the front. In other embodiments when the recess 17 is formed only in the lower surface 16, the accessory pad 10 may be mounted by lowering it onto the footrest 35 from above. In other embodiments when the recess 17 is formed in only a side, such as a first side 11, the accessory pad 10 may be slid onto the footrest 35 so the footrest 35 enters the opening 18 in the first side 11 and the accessory pad 10 surrounds the footrest 35.

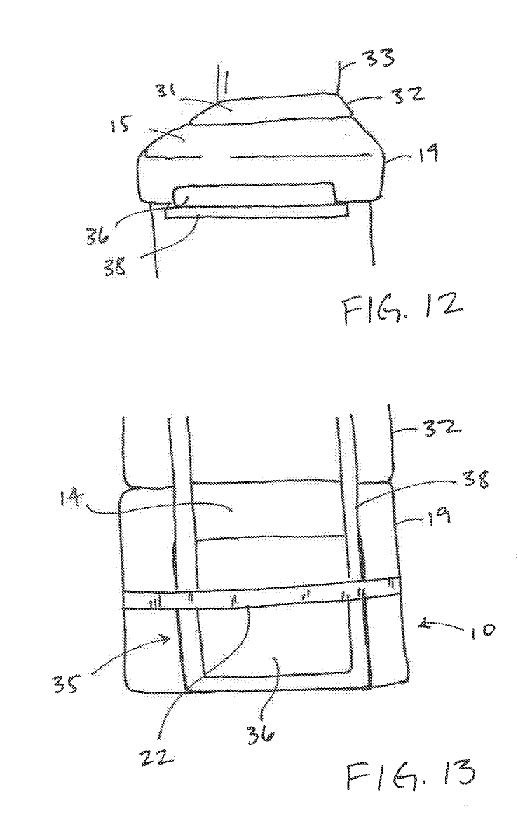

When mounted on the footrest 35, at least a portion of the body 19 of the accessory pad 10 fills the space between the footrest 35 and the seat cushion 32. For example, the recess 17 which receives a portion of the footrest 35 therein, such as the footrest pad 36, is surrounded by the remainder of the body 19 of the accessory pad 10, including sides 11, 12, 13, 14 and the upper surface 15. The portion of the body 19 between the recess 17 and the upper surface 15 fills in the vertical space between the footrest 35, such as the footrest pad. 36, and the upper seat surface 31 of the seat cushion 32. This portion of the body 19 may also be referred to as the upper surface 15. This brings the support surface on which a patient would place their leg or foot from a level below the upper seat surface 31 to a similar level. The upper surface 15 of the accessory pad 10 and the upper seat surface 31 of the seat cushion 32 may therefore be substantially co-planar. Examples are depicted in FIGS. 11 and 12.

The body 19 of the accessory pad 10 may also fill in space between the footrest 35 and the seat cushion 32 in the longitudinal direction. In at least one embodiment the accessory pad 10 may be mounted so it is adjacent to the seat cushion 32, as shown in FIGS. 9-13. As used herein, “adjacent” may include contacting, touching, abutting, or being next to though not necessarily touching. The upper surface 15 of the accessory pad 10 and the upper seat surface 31 of the seat cushion 32 may therefore form a continuous or substantially continuous surface between them. In such a position, a portion of the body 19 of the accessory pad 10 may fill the space between the footrest pad 36 and the seat cushion 32 in the longitudinal direction. For instance, one of the sides of the body 19 may fill this space, such as the fourth side 14 shown in FIG. 13. This also addresses the gap problem between the footrest 35 and the seat cushion 32.

In at least one embodiment, the recess 17 of the accessory pad 10 is configured to restrain the footrest 35, thereby limiting lateral and longitudinal movement and shifting of the accessory pad 10 thereon. As noted above, in some embodiments it may be preferable to have at least one restraint member 22 and/or at least one fastener 24 to further restrict and limit movement of the footrest 35 and accessory pad 10 relative to one another. These restraint member(s) 22 and fastener(s) 24 are as described above and need not be repeated here, except to note that the restraint member 22 may be disposed to at least partially surround the footrest 35, including the rails 38 as shown in FIG. 13.

When use of the accessory pad 10 is no longer desired or needed, such as when the patient examination or therapy is completed, the accessory pad 10 may be removed from the footrest 35 by simply lifting away or sliding the accessory pad 10 off the footrest 35 in the opposite direction from mounting. In embodiments where fastener(s) 24 and/or restraint member(s) 22 are used, these may be released from engagement prior to or along with removal of the accessory pad 10 from the footrest 35. The accessory pad 10 may then be stored separately from the medical examination device 30 and the footrest 35 returned to its stored position on the medical examination device 30, such as within the cavity or along a surface of the base 34.

Since many modifications, variations and changes in detail can be made to the described preferred embodiments, it is intended that all matters in the foregoing description and shown in the accompanying drawings be interpreted as illustrative and not in a limiting sense. Thus, the scope of the invention should be determined by the appended claims and their legal equivalents. Now that the invention has been described,

What is claimed is:

1. An accessory pad for a medical examination device of the type having an upper seat surface and a footrest, said accessory pad comprising:
a body having an upper surface, a lower surface and at least one side connecting said upper and lower surfaces;
a recess formed in said body dimensioned to receive and restrain at least a portion of said footrest; and
said upper surface of said body forming a support surface substantially co-planar with said upper seat surface of said medical examination device when mounted on said footrest.

2. The accessory pad of claim 1, wherein said recess is bounded by said upper surface and said at least one side.

3. The accessory pad of claim 2, wherein said recess is formed in at least one of said lower surface and said at least one side.

4. The accessory pad of claim 3, said body further comprising a plurality of sides, wherein said recess is formed in said lower surface and one of said sides.

5. The accessory pad of claim 4, wherein said recess is formed in said lower surface and two of said sides.

6. The accessory pad of claim 1, wherein said recess forms an interior surface within said body, said interior surface configured to receive and contact at least a portion of said footrest.

7. The accessory pad of claim 6, further comprising a fastener affixed to said interior surface of said recess configured to selectively and removably secure said body to said footrest.

8. The accessory pad of claim 1, wherein said recess provides a frictional fit between said recess and said footrest.

9. The accessory pad of claim 1, further comprising at least one fastener secured to said body and configured to selectively and removably retain said body on said footrest, said at least one fastener being at least one of a hook and loop fastener, snap, button and reusable adhesive.

10. The accessory pad of claim 9, further comprising at least one restraint member secured said body and configured to support and restrain said accessory pad on said footrest, said at least one restraint member being at least one of a strap, belt, and rope.

11. The accessory pad of claim 10, wherein said at least one restraint member is selectively and removably securable to said at least one fastener.

12. A medical examination device comprising:
a base;
a seat cushion affixed to said base having an upper seat surface;
a footrest affixed to and selectively positionable in at least one position extending outwardly from said base; and
an accessory pad selectively and removably mounted to said footrest, said accessory pad having:
(i) a body having an upper surface, a lower surface and at least one side connecting said upper and lower surfaces;
(ii) a recess formed in said body dimensioned to receive and restrain at least a portion of said footrest; and
(iii) said upper surface of said body forming a support surface substantially co-planar with said upper seat surface, forming a substantially continuous upper surface of said medical examination device.

13. The medical examination device of claim 12, wherein at least a portion of said body substantially fills a space between said footrest and said seat cushion.

14. The medical examination device of claim 13, wherein said body includes a plurality of sides, and one of said sides substantially fills said space between said footrest and said seat cushion.

15. The medical examination device of claim 13, wherein said body between said recess and said upper surface substantially fills said space between said footrest and said seat cushion.

16. The medical examination device of claim 12, wherein said accessory pad is removably mounted on said footrest adjacent to said seat cushion.

17. The medical examination device of claim 12, wherein said footrest is selectively positionable in at least one position by at least one of: (i.) extending outwardly from within a cavity in said base, (ii) extending outwardly from a side of said base, and (iii) rotating upward from a front surface of said base.

18. The medical examination device of claim 12, wherein said accessory pad is removably mounted on said footrest by a frictional fit between said recess and said corresponding portion of said footrest.

19. The medical examination device of claim 12, further comprising at least one fastener secured to said body and configured to selectively and removably retain said body on said footrest, said at least one fastener being at least one of a hook and loop fastener, snap, button and reusable adhesive.

20. The medical examination device of claim 19, further comprising at least one restraint member secured to said body and configured to support and restrain said accessory pad on said footrest, said at least one restraint member being at least one of a strap, belt, and rope.

21. The medical examination device of claim 20, wherein said at least one restraint member is selectively and removably securable to said at least one fastener.

22. The medical examination device of claim 12, further comprising a back cushion affixed to said base and spatially adjustable relative to said base and said seat cushion, wherein said back cushion, said seat cushion and said accessory pad collectively form a substantially continuous and planar upper surface of said medical examination device when said back cushion is positioned level with said seat cushion.
